(19) United States
(12) Patent Application Publication
(10) Pub. No.: US 2016/0188581 A1
(43) Pub. Date: Jun. 30, 2016

(54) CONTEXTUAL SEARCHES FOR DOCUMENTS

(71) Applicant: HEWLETT-PACKARD DEVELOPMENT COMPANY, L.P., Houston, TX (US)

(72) Inventors: Adi Kidron, Yehud (IL); Yael Keren, Yehud (IL); Yaniv Levin, Yahud (IL)

(21) Appl. No.: 14/909,655

(22) PCT Filed: Aug. 30, 2013
(86) PCT No.: PCT/US2013/057514

§ 371 Date: Feb. 2, 2016

(51) Int. Cl. G06F 17/30

(52) U.S. Cl. CPC G06F 17/30011; G06F 17/30554; G06F 17/3087; G06F 17/30867

(57) ABSTRACT

Example implementations relate to contextually searching for documents. A server may be communicatively coupled to a plurality of storage services. Contextual metadata associated with documents stored using the plurality of storage services may be stored on the server. In response to a contextual query, the plurality of storage services may be searched to identify documents relevant to the contextual query. Relevance of documents to the contextual query may be determined based on the contextual metadata stored on the server.

### BACKGROUND

Users of computing devices may use multiple devices to create, view, and edit documents and to communicate with other users. The same document may be accessed using several different devices; for example, a user may create a document using a desktop computer, edit the document on a notebook computer, and view the document on a mobile phone. Documents may be stored using local hard drives of devices as well as cloud storage services.

### BRIEF DESCRIPTION OF THE DRAWINGS

The following detailed description references the drawings, wherein:

FIG. 1 is a block diagram of an example server apparatus in communication with user devices and storage services to enable contextual searches for documents;

FIG. 2 is a block diagram of an example server apparatus in communication with user devices and storage services to enable sorting and displaying of documents;

FIG. 3 is a block diagram of an example computing device that includes a machine-readable storage medium encoded with instructions to display results of a contextual search;

FIG. 4 is a block diagram of an example computing device that includes a machine-readable storage medium encoded with instructions to initiate contextual queries and display results relevant to the queries;

FIG. 5A is a diagram of an example visualization of contextual search results;

FIG. 5B is a diagram of an example visualization of contextual search results that is based on a user selection;

FIG. 6 is a diagram of an example user interface for contextually searching for documents;

FIG. 7 is a flowchart of an example method for contextually searching for documents;

FIG. 8 is a flowchart of an example method for generating contextual metadata for documents;

FIG. 9 is a flowchart of an example method for initiating a contextual query for documents;

FIG. 10 is a flowchart of an example method for displaying representations of documents relevant to a contextual query;

FIG. 11 is a flowchart of an example method for displaying visualizations of contextual search results; and

FIG. 12 is a flowchart of an example method for modifying a display based on a user selection.

### DETAILED DESCRIPTION

The increasing availability and diversity of computing devices and storage services facilitate user access to documents, but may make the task of retrieving desired documents more difficult. As time goes by, a user may forget which storage service was used to store a particular document, and may forget about the existence of certain documents. A user wishing to find, for example, photos taken years ago during a vacation to Hawaii may spend a lot of time searching different storage services for a particular photo, or may find certain photos but not others because he has forgotten about photos stored using an unsearched storage service.

In light of the above, the present disclosure provides a unified interface for searching multiple storage services and allows users to initiate contextual searches for documents. Although a user may not remember the titles or content of desired documents or where such documents are stored, the user may remember a context of the documents, such as where he was or who he was with the last time he accessed the documents. The contextual searches and displays of contextual search results described in the present disclosure complement natural human memory patterns and provide users with a more intuitive and efficient search experience.

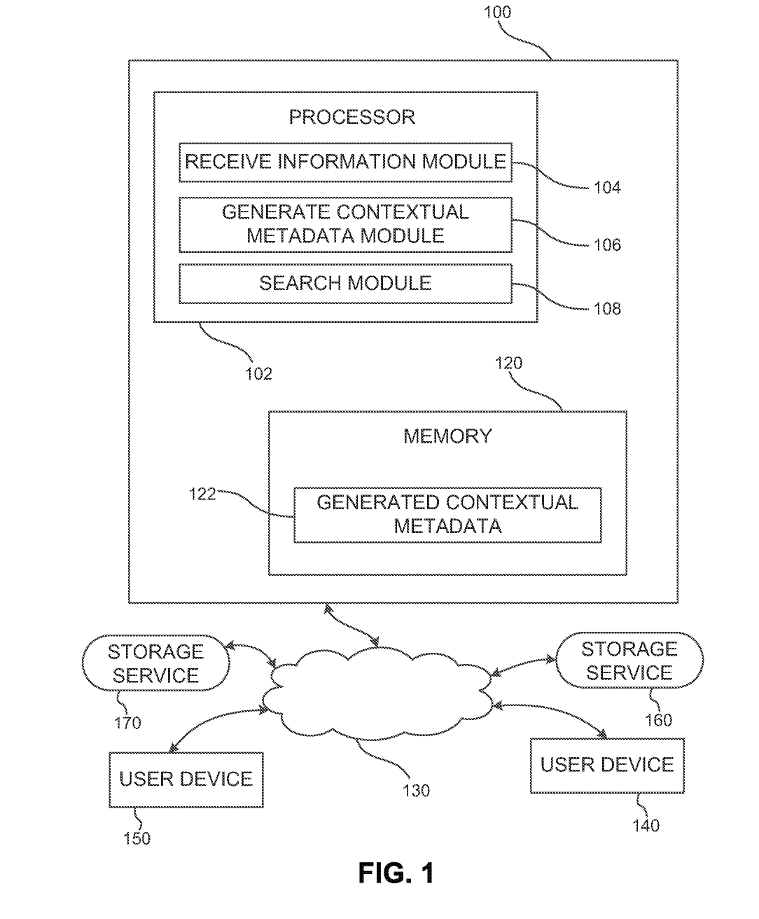

Referring now to the drawings, FIG. 1 is a block diagram of an example server apparatus 100 in communication with user devices and storage services to enable contextual searches for documents. The term “documents” as used herein refers to any form of media that that may be used to convey information. Documents may include textual information (e.g., articles, blog posts/comments, research papers, business/financial/medical records, reports, or manuals), videos, photographs, audio information (e.g., voicemails, podcasts, music recordings), e-mail messages, electronic calendar markers/reminders, websites, social media activity, or any combination of the above and/or other suitable documents.

Server apparatus 100 may be communicatively coupled to user devices 140 and 150 and to storage services 160 and 170 over network 130. Each of user devices 140 and 150 may be a client computing device, such as a notebook computer, a desktop computer, a workstation, a tablet computing device, a mobile phone, or an electronic book reader. The term “user device” as used herein refers to a device capable of receiving input from a user, collecting information related to a user, displaying information to a user, creating documents, and/or accessing documents. The term “storage service” as used herein refers to a file hosting service, an e-mail hosting service, a hard disk drive, a memory of a user device, or any other suitable form of storing documents. It should be understood that server apparatus 100 may communicate, over network 130 or another network, with additional user devices other than user devices 140 and 150, and/or with additional storage services other than storage services 160 and 170.

Server apparatus 100 may be a cloud server, a remote server, or any electronic device that is accessible to a client computing device and that is suitable for executing the functionality described below. Although server apparatus 100 is shown as a single device in FIG. 1, it should be understood that server apparatus 100 may be implemented as a combination of devices.

Server apparatus 100 may include processor 102. As illustrated in FIG. 1 and described in detail below, processor 102 may include modules 104, 106, and 108. A module may include a set of instructions encoded on a machine-readable storage medium and executable by processor 102 of server apparatus 100. In addition or as an alternative, a module may include a hardware device comprising electronic circuitry for implementing the functionality described below. Processor 102 may include a central processing unit (CPU), microprocessor (e.g., semiconductor-based microprocessor), and/or other hardware device suitable for performing functions of modules 104, 106, and/or 108.

Receive information module 104 may receive information from user devices, such as user device 140, user device 150, and/or other user devices communicatively coupled to server apparatus 100 through network 130 or another network. For example, receive information module 104 may receive information on what kinds of documents are created and/or accessed on user devices, the locations of user devices, when user devices are used and what they are used for, and/or the identity of users of user devices. Receive information module 104 may receive information (e.g., regarding location and/or user activity) that is periodically transmitted to server apparatus 100 from user devices, and/or may monitor activity on user devices to obtain information. In some implementations, receive information module 104 may monitor information collected by sensors (e.g., location tracking devices, Bluetooth sensors) in user devices.

Generate contextual metadata module 106 may generate, based on information received from user devices, contextual metadata associated with documents stored using storage services communicatively coupled to server apparatus 100. The term “contextual metadata”, as used herein with respect to a document, refers to metadata related to circumstances under which the document is created and/or accessed. For example, contextual metadata associated with a document may include an indication of a location (e.g., where the document was created/accessed), person (e.g., who created/accessed the document), event (e.g., situation for which the document was created/accessed), time (e.g., time stamp of when the document was created/accessed), and/or date associated with the document. Generated contextual metadata 122 may be stored in memory 120 of server apparatus 100. Memory 120 may be a virtual memory or any electronic, magnetic, optical, or other physical storage device suitable for storing contextual metadata. Server 100 may maintain contextual metadata in memory 120. Maintaining contextual metadata may include generating and storing new contextual metadata, updating existing metadata, and/or deleting outdated contextual metadata.

Generate contextual metadata module 106 may generate, based on information received from a user device, contextual metadata associated with a document created or accessed using a different user device. For example, user device 140 may be a mobile phone and user device 150 may be a notebook computer. Receive information module 104 may receive login information or other user identification information from user devices 140 and 150 indicating that both devices are used by the same user. User device 140 may have a global positioning system (GPS) and may transmit coordinates of its location to server apparatus 100. Generate contextual metadata module 106 may use the coordinates transmitted by user device 140 to generate contextual metadata associated with a document accessed using user device 150. The contextual metadata may include an indication of a location where the document was accessed.

Search module 108 may search, in response to a contextual query, storage services 160 and 170, and other storage services communicatively coupled to server apparatus 100, to identify documents relevant to the contextual query. The relevance of documents to the contextual query may be determined based on generated contextual metadata associated with the documents. As used herein, the term “contextual query” refers to a request to search for documents created and/or accessed under a particular circumstance. A contextual query may specify a circumstance, such as a location, event, or situation, under which documents are created or accessed. For example, a contextual query may request a search for documents created and/or accessed during a particular academic conference, or documents created and/or accessed while a user was visiting a particular city. A search performed in response to a contextual query may be referred to herein as a contextual search. In some implementations, search module 108 may receive and/or parse a contextual query transmitted from a user device (e.g., user device 140 or 150) to server apparatus 100.

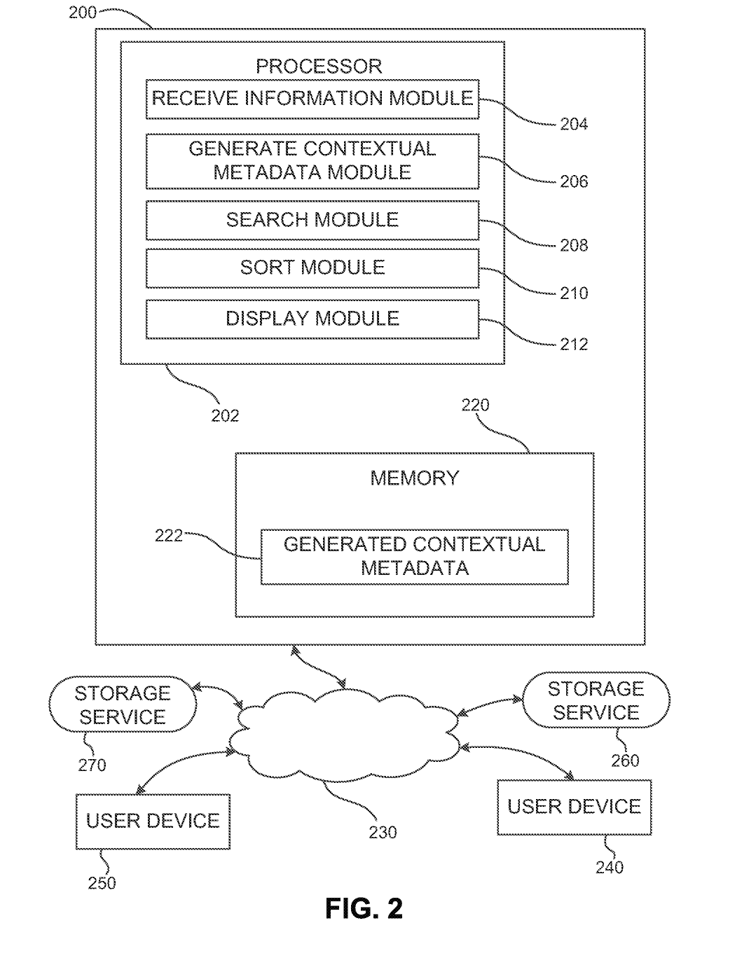

FIG. 2 is a block diagram of an example server apparatus 200 in communication with user devices and storage services to enable sorting and displaying of documents. Server apparatus 200 may be communicatively coupled to user devices 240 and 250 and to storage services 260 and 270 over network 230. Each of user devices 240 and 250 may be a client computing device, such as a notebook computer, a desktop computer, a workstation, a tablet computing device, a mobile phone, an electronic book reader, or any other electronic device suitable for displaying contextual search results. Each of storage services 260 and 270 may be a file hosting service, an e-mail hosting service, a hard disk drive (e.g., on a server or user computing device), or any other suitable form of storing documents. It should be understood that server apparatus 200 may communicate, over network 230 or another network, with additional user devices other than user devices 240 and 250, and/or with additional storage services other than storage services 260 and 270.

Server apparatus 200 may be a cloud server, a remote server, or any electronic device that is accessible to a client computing device and that is suitable for executing the functionality described below. Although server apparatus 200 is shown as a single device in FIG. 2, it should be understood that server apparatus 200 may be implemented as a combination of devices.

Server apparatus 200 may include processor 202. As illustrated in FIG. 2 and described in detail below, processor 202 may include modules 204, 206, 208, 210, and 212. A module may include a set of instructions encoded on a machine-readable storage medium and executable by processor 202 of server apparatus 200. In addition or as an alternative, a module may include a hardware device comprising electronic circuitry for implementing the functionality described below. Processor 202 may include a central processing unit (CPU), microprocessor (e.g., semiconductor-based microprocessor), and/or other hardware device suitable for performing functions of modules 204, 206, 208, 210, and/or 212. Modules 204, 206, and 208 of processor 202 of server apparatus 200 may be analogous to (e.g., have functions and/or components similar to) modules 104, 106, and 108 of processor 102 of server apparatus 100.

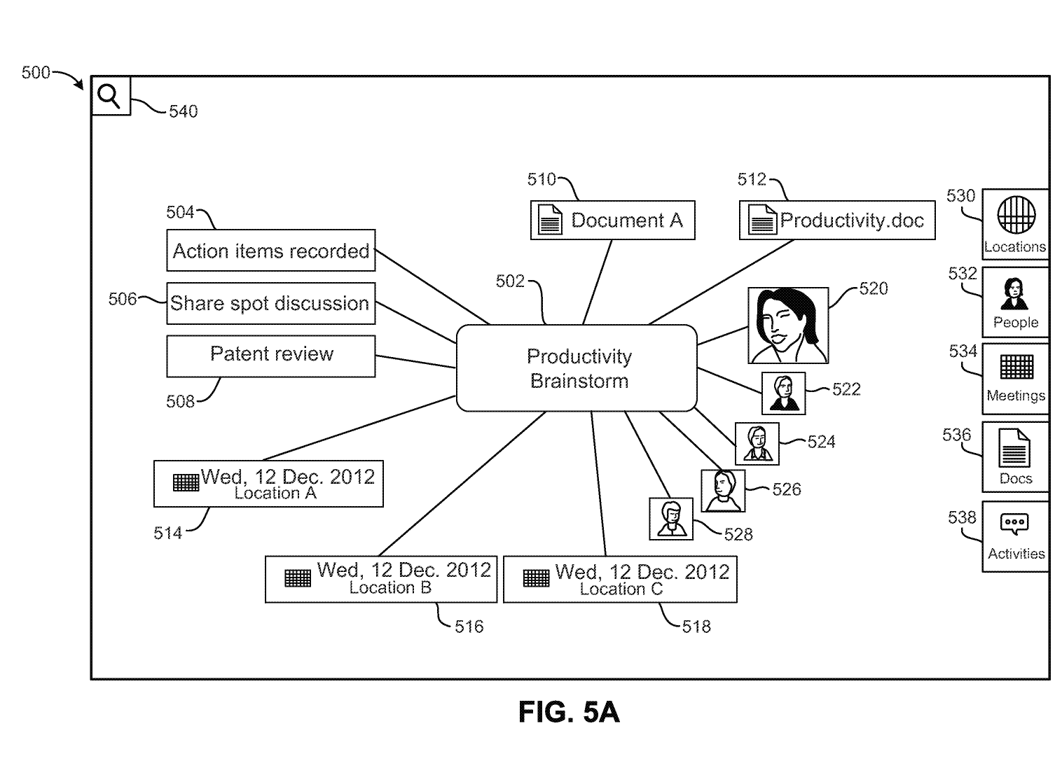

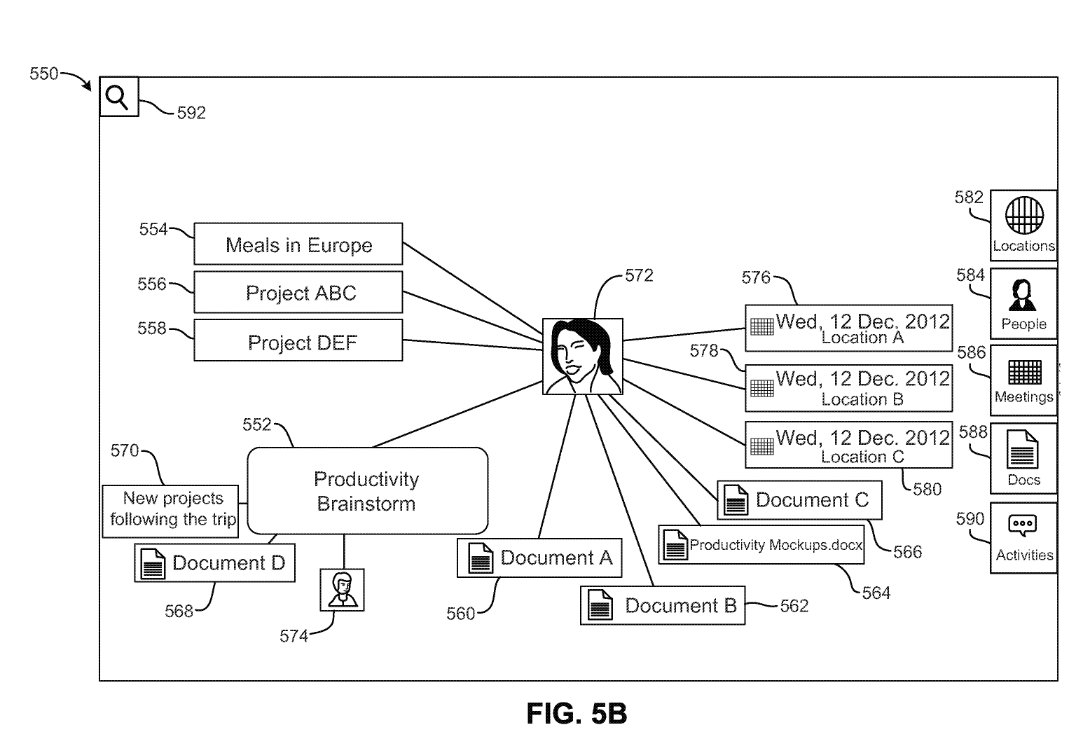

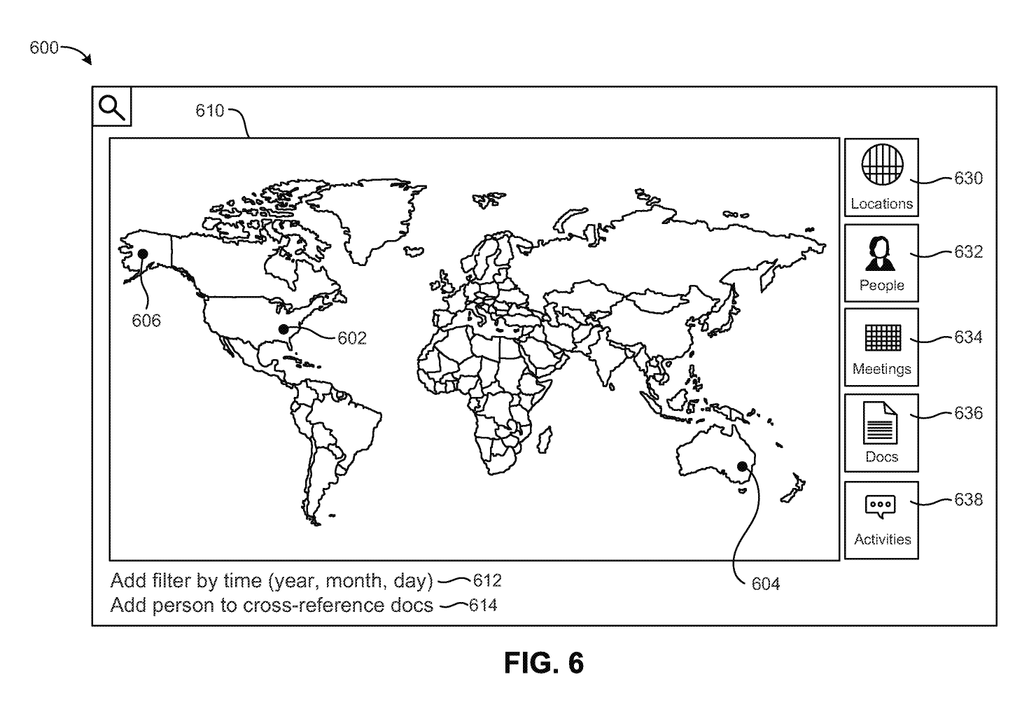

Search module 208 may identify, based on generated contextual metadata 222 stored in memory 220, documents that are stored using storage services 260 and 270 and that are relevant to a contextual query. Sort module 210 may sort, based on a filter, the identified documents into a first plurality of documents and a second plurality of documents. The first plurality of documents may be documents that satisfy a criterion of the filter, and the second plurality of documents may be documents that do not satisfy a criterion of the filter (e.g., documents that get “filtered out”). For example, a filter may be applied to separate documents created on or before a certain date from documents created after the date. The first plurality of documents may be documents created on or before the date, and the second plurality of documents may be documents created after the date. To determine whether documents meet a filter criterion, sort module 210 may use generated contextual metadata 222 associated with the documents. The contextual metadata may include indications of circumstances under which documents are created or accessed (e.g., indications of locations where documents were created or accessed, or of events or situations for which documents were created or accessed). A filter may be selected by a user, as discussed further below with respect to FIGS. 5A, 5B, and 6.

Sort module 210 may sort documents using multiple filters at the same time. For example, the first plurality of documents may be documents created on or before a certain date and at a certain location. The second plurality of documents may be documents created after the date and/or at a different location.

Display module 212 may cause representations of documents relevant to a contextual query to be displayed on a user device (e.g., user device 240 or 250) communicatively coupled to server apparatus 200. Representations of documents stored using different storage services may be concurrently displayed on the user device. In some implementations, display module 212 may cause representations of people associated with documents to be displayed on a user device. People associated with a document may include a person who created the document, a person who viewed/edited/otherwise accessed the document, a person who sent or received the document, a person who was present when the document was created/viewed/edited/otherwise accessed, and/or a person associated with similar documents (e.g., in terms of type, location, time). The term “representation”, as used herein with respect to a document or person, refers to any visual indication of the document or person. Representations of documents or people may include icons, photos, screen shots, and/or text (e.g., excerpts/titles of documents, names/titles of people). In implementations where a filter is used to sort documents into a first plurality of documents and a second plurality of documents, display module 212 may cause representations of the first plurality of documents to be displayed on a user device.

Display module 212 may transmit, to a user device communicatively coupled to server apparatus 200 through network 230 or through another network, information that identifies documents whose representations are to be displayed. For example, display module 212 may transmit a list of titles of the documents over network 230 to user device 240. Display module 212 may transmit other information regarding the documents, such as the type (e.g., photo, video, meeting minutes, e-mail) of each document and/or contextual metadata associated with the documents. In some implementations, processor 202 may retrieve each of the documents from a respective storage service and transmit a copy of each of the documents to a user device. In some implementations, display module 212 may transmit instructions for rendering representations of the documents to a user device. Displays of representations of documents are further discussed below with respect to FIGS. 5A, 5B, and 6.

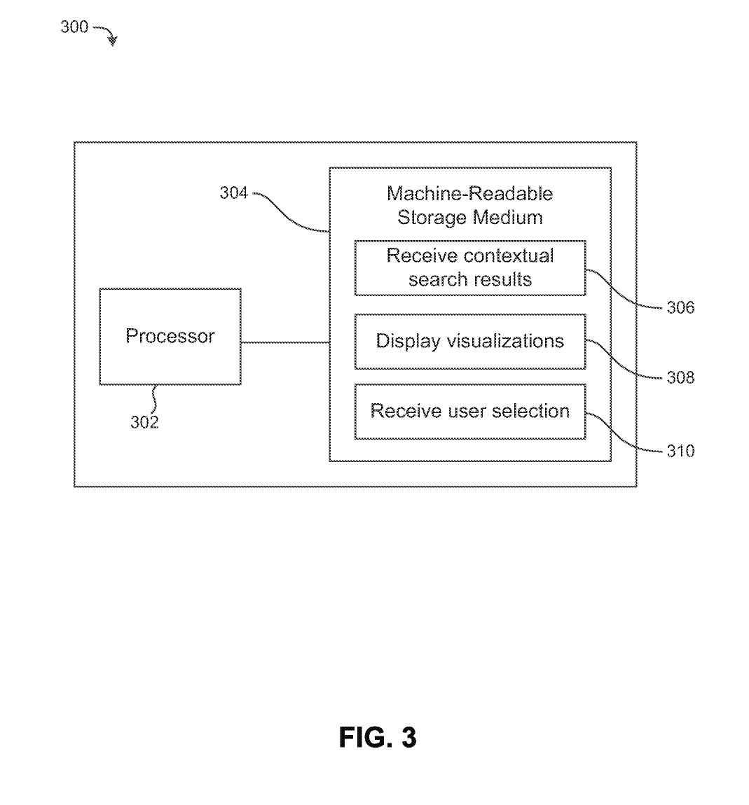

FIG. 3 is a block diagram of an example computing device 300 that enables displaying results of a contextual search. Computing device 300 may be a client computing device, such as a notebook computer, a desktop computer, a workstation, a tablet computing device, a mobile phone, an electronic book reader, or any other electronic device suitable for displaying a visualization of a data set. Computing device 300 may be implemented as user device 140, user device 150, user device 240, user device 250, or another suitable device or combination of devices. In FIG. 3, computing device 300 includes processor 302 and machine-readable storage medium 304.

Processor 302 may include a central processing unit (CPU), microprocessor (e.g., semiconductor-based microprocessor), and/or other hardware device suitable for retrieval and/or execution of instructions stored in machine-readable storage medium 304. Processor 302 may fetch, decode, and/or execute instructions 306, 308, and 310 to enable displaying results of a contextual search, as described below. As an alternative or in addition to retrieving and/or executing instructions, processor 302 may include an electronic circuit comprising a number of electronic components for performing the functionality of instructions 306, 308, and/or 310.

Machine-readable storage medium 304 may be any suitable electronic, magnetic, optical, or other physical storage device that contains or stores executable instructions. Thus, machine-readable storage medium 304 may include, for example, Random Access Memory (RAM), an Electrically Erasable Programmable Read-Only Memory (EEPROM), a storage device, an optical disc, and the like. In some implementations, machine-readable storage medium 304 may include a non-transitory storage medium, where the term “non-transitory” does not encompass transitory propagating signals. As described in detail below, machine-readable storage medium 304 may be encoded with a set of executable instructions 306, 308, and 310 to receive contextual search results, display visualizations, and receive user selections.

Receive contextual search results instructions 306 may receive contextual search results from a server, such as server apparatus 100 or 200. The server may be communicatively coupled to computing device 300 and to a plurality of storage services, such as storage services 160 and 170. The contextual search results may be relevant to a contextual query and may identify a plurality of documents stored using different storage services.

Display visualizations instructions 308 may display a visualization of contextual search results. A visualization may include representations of documents relevant to a contextual query and representations of people associated with the documents. Based on a user selection, display visualizations instructions 308 may change positions of representations of documents in, add representations of documents to, and eliminate representations of documents from a visualization. Display visualizations instructions 308 may display a first visualization that includes representations of various documents and representations of people associated with the documents. A user may select a representation from the first visualization, and display visualizations instructions 308 may display a second visualization based on the selected representation. For example, a user may select a representation of a person from the first visualization, and the second visualization may include representations of documents associated with the person whose representation was selected, and representations of people associated with such documents.

In some implementations, a size of a representation in a visualization may be based on a level of relevance of the respective document or person to a contextual query. The more relevant a document or person is to the contextual query, the bigger the respective representation may appear in the visualization. Relevance of a document may be determined based on, for example, the number of times a document has been accessed/viewed (e.g., documents that have been accessed/viewed more times may be more relevant), people associated with the document (e.g., a document created/accessed/viewed by a company's board members may be more relevant), the date a document was created (e.g., documents that have been created more recently may be more relevant), and/or the date a document was last accessed/edited (e.g., documents that have been accessed/edited more recently may be more relevant). Relevance of a person may be determined based on, for example, how often a user of computing device 300 communicates with the person (e.g., people with whom the user communicates more often may be more relevant), and/or a person's level of seniority within a company (e.g., higher ranked officials may be more relevant). It should be understood that varying levels of relevance may be indicated in ways other than sizing of representations. For example, representations of more relevant documents/people may have bolder graphics/text, brighter/darker colors, and/or flashing graphics/text/borders.

Receive user selection instructions 310 may receive a user selection related to a visualization. A user may select a representation of a document or person in a visualization, and/or a filter to apply to documents represented in a visualization. Receive user selection instructions 310 may detect a position of a cursor or other selection indicator, and/or detect a location of user-applied pressure on a touch screen of computing device 300, to determine whether a user selection has been made and what has been selected. When a first visualization including representations of documents is displayed, a user selection of a filter to apply to the documents may cause representations of a subset of the documents to be displayed in a second visualization. The subset of the documents may be determined based on the selected filter. For example, the selected filter may be a date filter, and the subset of the documents may be documents that were created after a specified date.

In some implementations, a user selection of a displayed representation may cause a filter to be applied. For example, if a representation of a person is selected from a first visualization, the documents represented in the first visualization may be sorted into a first plurality of documents associated with the selected person, and a second plurality of documents that are not associated with the selected person. The first plurality of documents may be displayed in a second visualization.

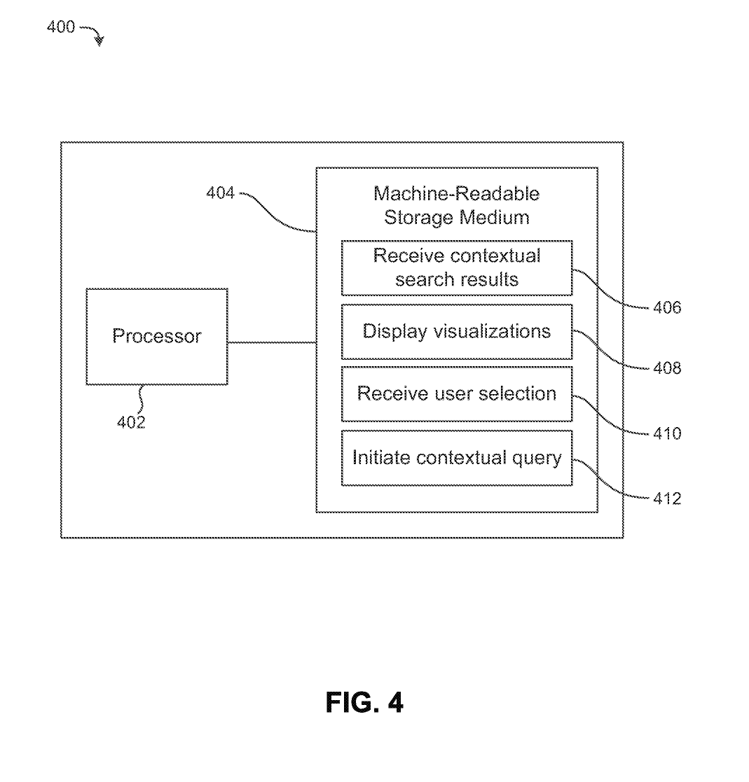

FIG. 4 is a block diagram of an example computing device 400 that includes a machine-readable storage medium encoded with instructions to initiate contextual queries and display results relevant to the queries. Device 400 may be a client computing device, such as a notebook computer, a desktop computer, a workstation, a tablet computing device, a mobile phone, an electronic book reader, or any other electronic device suitable for displaying a visualization of a data set. Computing device 400 may be implemented as user device 140, user device 150, user device 240, user device 250, or another suitable device or combination of devices. In FIG. 4, computing device 400 includes processor 402 and machine-readable storage medium 404.

As with processor 302 of FIG. 3, processor 402 may include a central processing unit (CPU), microprocessor (e.g., semiconductor-based microprocessor), and/or other hardware device suitable for retrieval and/or execution of instructions, such as instructions stored in machine-readable storage medium 404. Processor 402 may fetch, decode, and/or execute instructions 406, 408, 410, and 412 to enable initiating contextual queries and displaying results relevant to the queries, as described below.

As an alternative or in addition to retrieving and/or executing instructions, processor 402 may include an electronic circuit comprising a number of electronic components for performing the functionality of instructions 406, 408, 410, and/or 412. As with machine-readable storage medium 304 of FIG. 3, machine-readable storage medium 404 may be any suitable physical storage device that stores executable instructions. Instructions 406, 408, and 410 of storage medium 404 may be analogous to instructions 306, 308, and 310 of storage medium 304.

Initiate contextual query instructions 412 may initiate contextual queries based on user inputs to computing device 400. A contextual query may be initiated based on a search term that a user enters into computing device 400, or based on a user selection from a visualization displayed on computing device 400. Initiate contextual query instructions 412 may transmit a contextual query to a server, such as server apparatus 100 or 200, over a network, such as network 130 or 230. The server may search various storage services (e.g., storage services 160 and 170) for documents relevant to the contextual query, and may send contextual search results relevant to the contextual query (e.g., information identifying the relevant documents) to computing device 400. Receive contextual search results instructions 406 may receive the contextual search results from the server.

In some implementations, initiate contextual query instructions 412 may initiate a contextual query based on a selected representation from a displayed visualization. For example, a displayed visualization may include representations of documents relevant to a first contextual query and representations of people associated with the documents. Receive user selection instructions 410 may receive a user selection of a representation of a person, and initiate contextual query instructions 412 may initiate a second contextual query requesting documents related to the selected person. Documents associated with the selected person may include documents created by the selected person, documents that the selected person has accessed/edited, documents created/accessed/edited at a meeting attended by the selected person, and/or documents similar to documents that the selected person has created/accessed/edited. Initiate contextual query instructions 412 may transmit the second contextual query to a server, which may search a plurality of storage services for documents relevant to the second contextual query. Receive contextual search results instructions 406 may receive, from the server, contextual search results relevant to the second contextual query. The received contextual search results may identify documents, stored using the plurality of storage services, that are relevant to the second contextual query.

Display visualizations instructions 408 may display a visualization that includes representations of documents relevant to the second contextual query. The visualization may also include representations of people associated with the documents relevant to the second contextual query, and/or representations of a subset of the documents relevant to the first contextual query. For example, display visualizations instructions 408 may display, after a first contextual query, a first visualization that includes representations of a first plurality of documents created by a particular person on or before a particular date, and representations of people associated with such documents. A user may select a representation of a person from the first visualization, and initiate contextual query instructions 412 may initiate a second contextual query to search for documents related to the selected person. Display visualizations instructions 408 may display a second visualization that includes representations of a second plurality of documents related to the selected person, and representations of people related to the second plurality of documents. Some people related to the second plurality of documents may also be related to a subset of the first plurality of documents. The second visualization may include representations of this subset of the first plurality of the documents.

Displays of contextual search results and user interfaces for initiating contextual queries will now be discussed with respect to FIGS. 5A, 5B, and 6. FIG. 5A is a diagram of an example visualization 500 of contextual search results. Visualization 500 may be displayed on a user device, such as user device 240 or 250, based on contextual search results received from a server, such as server apparatus 200. The contextual search results may include documents relevant to a contextual query requesting documents related to an event called “Productivity Brainstorm”, represented by box 502 in visualization 500. The contextual search results may be arranged in a star diagram in visualization 500, with the subject of the search (i.e., Productivity Brainstorm) in the middle of the star diagram and representations of relevant documents and people radiating outward.

Productivity Brainstorm may be a work-related event in a certain city attended by employees of a company, during which multiple meetings between employees, customers, and/or vendors take place. An employee who attended Productivity Brainstorm may have brought, for example, user devices 240 and 250 with him, and may have traveled to the city where Productivity Brainstorm was held from his home city. The employee may have attended several meetings involving different people, and may have used user devices 240 and 250 to create, access, and/or edit various documents in preparation for, during, and/or after the meetings. The documents may be stored using various storage services, such as the company's cloud server, hard drives of user devices 240 and 250, e-mail accounts, and third-party file hosting services (e.g., Dropbox, Google Docs). User devices 240 and 250 may be communicatively coupled to server apparatus 200 and the various storage services. Server apparatus 200 may generate and store, in a manner similar to that discussed above with respect to FIG. 1, contextual metadata associated with the various documents created, accessed, and/or edited during Productivity Brainstorm.

After the employee returns to his home city, he may wish to view documents that he created/accessed/edited while he was attending Productivity Brainstorm, but the employee may not remember where such documents are stored. The employee may enter a contextual query into, for example, user device 240 to search for documents relevant to Productivity Brainstorm. User device 240 may transmit the contextual query to server apparatus 200, which may search storage services communicatively coupled to server apparatus 200 to identify documents relevant to the contextual query (i.e., documents relevant to Productivity Brainstorm). The relevance of documents to the contextual query may be determined based on contextual metadata associated with the documents and stored on server apparatus 200. User device 240 may receive contextual search results from server apparatus 200 and display them in visualization 500.

Visualization 500 may include representations of various documents relevant to Productivity Brainstorm. Boxes 514, 516, and 518 in visualization 500 may be representations of calendar reminders for meetings that the employee attended during Productivity Brainstorm. The calendar reminders may include information such as when the meeting occurred, where the meeting took place, who attended the meeting, and/or the topic(s) of the meeting. Boxes 510 and 512 in visualization 500 may be representations of meeting minutes or other text files that the employee created/accessed/edited during Productivity Brainstorm.

Boxes 520, 522, 524, 526, and 528 of visualization 500 may be representations of people relevant to Productivity Brainstorm. Although boxes 520, 522, 524, 526, and 528 are shown as photos of respective people, it should be understood that other ways of identifying respective people (e.g., names, job titles) may be used as an alternative or in addition to photos. The people represented by boxes 520, 522, 524, 526, and 528 may be people who created/accessed/edited documents represented by boxes 510 and 512, people the employee communicated with (e.g., in person or via e-mail, text message, phone call/voicemail, online chat) during Productivity Brainstorm, and/or people who attended any of the meetings represented by boxes 514, 516, and 518.

Server apparatus 200 may cross-reference information obtained from various user devices and storage services to determine whether a document or person is relevant to a contextual query. For example, in the case of the Productivity Brainstorm query, server apparatus 200 may access the employee's itinerary on one of the employee's user devices to identify a date range that the employee was out of town, access the employee's Outlook calendar to determine that the employee attended Productivity Brainstorm during the identified date range, and identify stored documents that have timestamps falling within the identified date range. As another example, server apparatus 200 may be communicatively coupled to user devices of other people present at the conference, and may use GPS information from others' user devices and from a user device used by the employee to determine who else was present at a meeting the employee attended.

In some implementations, visualization 500 may include indications of activities related to Productivity Brainstorm. Boxes 504, 506, and 508 may be indications of activities that happened during Productivity Brainstorm, or activities the employee is involved in that are related to his participation in Productivity Brainstorm. For example, box 504 may represent a list of tasks that the employee was assigned during Productivity Brainstorm that he has not yet completed. Boxes 506 and 508 may indicate follow-up events related to Productivity Brainstorm that the employee may attend after returning to his home city.

Icons 530, 532, 534, 536, and 538 of visualization 500 may allow a user to filter contextual search results and/or initiate a new contextual query. A user selection of Locations icon 530 may allow a user to input a location for filtering the contextual search results or for initiating a new contextual query to search for documents related to the location. If the location is input to filter the contextual search results, representations of people or documents not related to the specified location may disappear from visualization 500. A user selection of People icon 532 may cause all representations except for representations of people to disappear from visualization 500, or may allow a user to filter the contextual search results based on relevance to a specified person, or may allow a user to initiate a new contextual query to search for documents related to the specified person. Analogous effects may occur for a user selection of Meetings icon 534, Docs icon 536, or Activities icon 538. A user may also initiate a new contextual query by selecting icon 540.

Each of boxes 504, 506, 508, 510, 512, 514, 516, 518, 520, 522, 524, 526, and 528 in visualization 500 may be connected to box 502 by a line, indicating a relationship between the boxes on each end of the line. In some implementations, the sizes of the boxes and/or the lengths of the lines may indicate the level of relevance the respective document/person/activity has to the subject of the contextual query. For example, larger boxes may indicate higher relevance, and longer lines may indicate lower relevance. Determining levels of relevance is discussed above with respect to FIG. 3.

A selection of any of boxes 502, 504, 506, 508, 510, 512, 514, 516, 518, 520, 522, 524, 526, and 528 in visualization 500 (e.g., using a cursor or, in the case of a touch screen device, a tap in a region of the screen where a box is displayed) may cause more information about the respective document/person/activity to be displayed. For example, a description of the selected document/person/activity may be displayed, and/or other documents/people/activities related to the selected document may be displayed. In some implementations, a selection of a representation of a document may cause the document to be opened. In some implementations, a user may select a box in visualization 500 and drag the box toward the center of visualization 500, causing the visualization to be modified, as discussed below with respect to FIG. 5B.

FIG. 5B is a diagram of an example visualization 550 of contextual search results that is based on a user selection. Visualization 550 may be displayed on, for example, user device 240 after box 520 in the star diagram of visualization 500 is selected and dragged to the middle of visualization 500. The movement of box 520 may initiate a contextual query whose subject is the person represented by box 520, and may modify visualization 500 to look like visualization 550.

Visualization 550 may include a subset of the representations in visualization 500. Box 572, which represents the same person as box 520 of visualization 500, may be at the center of the star diagram of visualization 550. Boxes 560, 576, 578, and 580 of visualization 550 may represent the same documents as boxes 510, 514, 516, and 518 respectively, of visualization 500. Such documents may be related to the person represented by box 572; for example, the person may have created/accessed/edited the text file represented by box 560, and may have attended the meetings represented by boxes 576, 578, and 580. The Productivity Brainstorm box, box 552, may be off to the side in visualization 550 instead of in the middle, as it was in visualization 500. Some representations connected to Productivity Brainstorm box 502 in visualization 500 may also appear in visualization 550 and be connected to Productivity Brainstorm box 552; for example, the same person is represented by box 528 in visualization 500 and box 574 in visualization 550.

Visualization 550 may also include representations not in visualization 500. In particular, visualization 550 may include representations of documents/people/activities that were identified in response to the contextual query initiated by the movement of box 520 and that were not represented in visualization 500. Such documents/people/activities may involve the person represented by box 572 but not the employee using user device 240. Box 568 may represent a text file that the person represented by box 572 created/accessed/edited during Productivity Brainstorm. Box 570 may be an indication of a list of tasks that the person represented by box 572 was assigned as a result of her attendance at Productivity Brainstorm. Each of boxes 568 and 570 may be connected to box 552 by a line to indicate a relationship to Productivity Brainstorm. Boxes 562, 564, and 566 in visualization 550 may be representations of text files that the person represented by box 572 has created/accessed/edited. Boxes 554, 556, and 558 may be indications of activities in which the person represented by box 572 is/was involved. Each of boxes 554, 556, 558, 562, 564, and 568 may or may not be related to Productivity Brainstorm, and may be connected to box 572 by a line, indicating a relationship between the boxes on each end of the line. The sizes of the boxes acid/or the lengths of the lines in visualization 550 may indicate the level of relevance the respective document/person/activity has to the person represented by box 572.

A selection of any of boxes 552, 554, 556, 558, 560, 562, 564, 566, 568, 570, 572, 574, 576, 578, and 580 in visualization 550 may cause more information about the respective document/person/activity to be displayed, or, if the selected box is a representation of a document, may cause the respective document to be opened, as discussed above with respect to FIG. 5A. A user may modify visualization 550 and/or initiate a new contextual query by selecting a box and dragging it toward the center of visualization 550, or by selecting any of icons 582, 584, 586, 588, 590, and 592. Icons 582, 584, 586, 588, 590, and 592 of visualization 550 may be analogous to icons 530, 532, 534, 536, 538, and 540, respectively, of visualization 500.

FIG. 6 is a diagram of an example user interface 600 for contextually searching for documents. User interface 600 may be displayed on a user device, such as user device 140, 150, 240, or 250. User interface 600 may include a map 610 having indications 602, 604, and 606 of cities associated with documents that a user of the user device has created, accessed, and/or edited, regardless of which storage services are used to store the documents. Map 610 and the locations of indications on map 610 may be generated based on contextual metadata stored on a server, such as server apparatus 100 or 200. Although indications 602, 604, and 606 may correspond to cities in map 610, it should be understood that indications may correspond to larger geographical regions, such as states, regions, countries, or continents. It should also be understood that more indications in addition to and/or instead of indications 602, 604, and 606 may be displayed in map 610 of user interface 600. A user may select one of indications 602, 604, and 606 to initiate a contextual query to search for documents related to the city corresponding to the selected indication. A user may also initiate a contextual query based on a location by selecting Locations icon 630 of user interface 600.

A user may change the number of indications of cities displayed in map 610 by selecting option 612 and/or option 614. Selecting option 612 may allow the user to specify a year, month, and/or day to change map 610 from showing indications of all cities where the user has created/accessed/edited documents to showing indications of cities where the user has created/accessed/edited documents during the specified year/month/day. Selecting option 614 may allow the user to specify a person and change map 610 from showing indications of all cities where the user has created/accessed/edited documents to showing indications of cities where the user has created/accessed/edited documents associated with the specified person (e.g., documents the specified person has created/accessed/edited, documents that have been the subject of communications between the user and the specified person). A similar effect may be achieved by selecting People icon 632 in user interface 600.

A user may change the number of indications of cities displayed in map 610 and/or initiate a contextual search by selecting Meetings icon 634, Docs icon 636, and/or Activities icon 638. In some implementations, a selection of Meetings icon 634 may change map 610 from showing indications of all cities where the user has created/accessed/edited documents to showing indications of cities related to documents pertaining to meetings in general or to a specified meeting. A selection of Docs icon 636 may change map 610 from showing indications of all cities where the user has created/accessed/edited documents to showing indications of cities where the user has created/accessed/edited text files. A selection of Activities icon 638 may change map 610 from showing indications of all cities where the user has created/accessed/edited documents to showing indications of cities related to documents pertaining to activities in general or to a specified activity. In some implementations, a selection of Meetings icon 634, Docs icon 636, or Activities icon 638 may initiate a contextual search query to search for documents related to a specified meeting, text file, or activity, respectively.

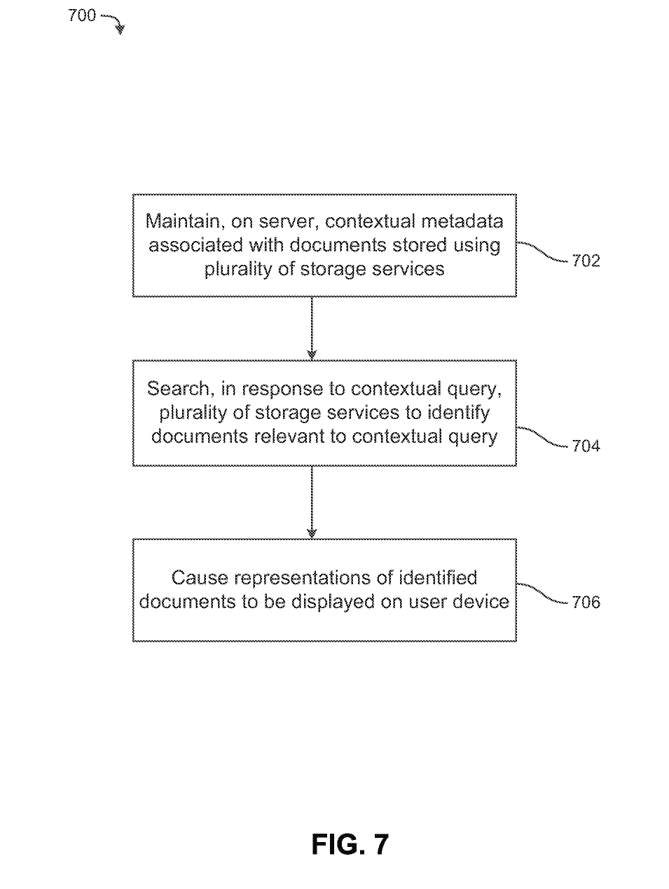

Methods for contextually searching for documents and displaying contextual search results will now be discussed with respect to FIGS. 7-12. FIG. 7 is a flowchart of an example method 700 for contextually searching for documents. Although execution of method 700 is described below with reference to server apparatus 100 of FIG. 1, it should be understood that execution of method 700 may be performed by other suitable devices, such as server apparatus 200. Method 700 may be implemented in the form of executable instructions stored on a machine-readable storage medium, such as memory 120, and/or in the form of electronic circuitry.

Method 700 may start in block 702, where server apparatus 100 may maintain contextual metadata associated with documents stored using a plurality of storage services. Maintaining contextual metadata may include generating and storing new contextual metadata, updating existing metadata, and/or deleting outdated contextual metadata. The contextual metadata may include indications of circumstances under which documents are created or accessed, as discussed above with respect to FIG. 1. For example, the contextual metadata may include indications of locations where documents were created or accessed, or of events or situations for which documents were created or accessed. The contextual metadata may be generated based on information from user devices, such as user devices 140 and 150, communicatively coupled to server apparatus 100.

Next, in block 704, server apparatus 100 may search, in response to a contextual query, the plurality of storage services to identify documents relevant to the contextual query. The contextual query may specify a circumstance under which documents are created or accessed. For example, the contextual query may specify a location, event, or situation. Relevance of documents to the contextual query may be determined based on contextual metadata.

Finally, in block 706, server apparatus 100 may cause representations of the identified documents to be displayed on a user device, such as user device 140 or 150. Representations of identified documents stored using different storage services may be concurrently displayed. Representations of identified documents may be arranged in a star diagram, as illustrated in and discussed with respect to FIGS. 5A and 5B.

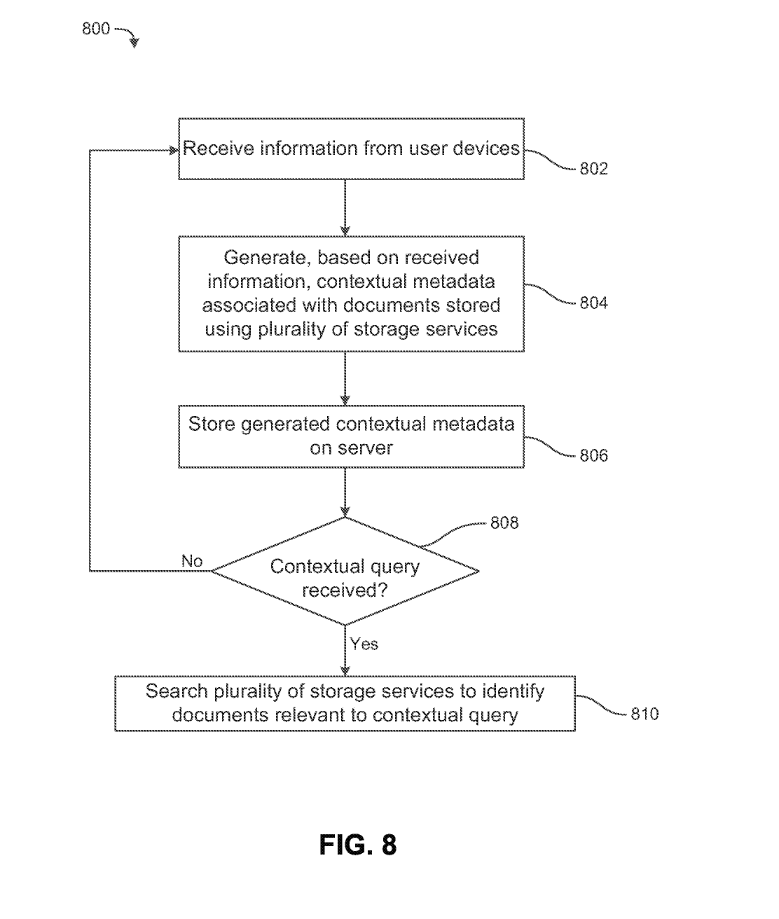

FIG. 8 is a flowchart of an example method 800 for generating contextual metadata for documents. Although execution of method 800 is described below with reference to server apparatus 100 of FIG. 1, it should be understood that execution of method 800 may be performed by other suitable devices, such as server apparatus 200. Method 800 may be implemented in the form of executable instructions stored on a machine-readable storage medium, such as memory 120, and/or in the form of electronic circuitry.

Method 800 may start in block 802, where server apparatus 100 may receive information from user devices. The user devices, such as user devices 140 and 150, may be communicatively coupled to server apparatus 100 via a network, such as network 130. Information received from user devices may include what kinds of documents are created and/or accessed on user devices, the locations of user devices, when user devices are used and what they are used for, and/or the identity of users of user devices.

Next, in block 804, server apparatus 100 may generate, based on the received information, contextual metadata associated with documents stored using a plurality of storage services. Contextual metadata associated with a document created/accessed/edited using a user device may be generated based on information received from the same device or from a different device, as discussed above with respect to FIG. 1. In block 806, server apparatus 100 may store the generated contextual metadata. The generated contextual metadata may be stored in, for example, memory 120 of server apparatus 100.

In block 808, server apparatus 100 may determine whether a contextual query has been received. When server apparatus 100 determines that a contextual query has not been received, method 800 may loop back to block 802. When server apparatus 100 determines that a contextual query has been received, server apparatus 100 may proceed to block 810, in which server apparatus 100 may search a plurality of storage services to identify documents relevant to the contextual query. Relevance of documents to the contextual query may be determined based on contextual metadata stored on server apparatus 100.

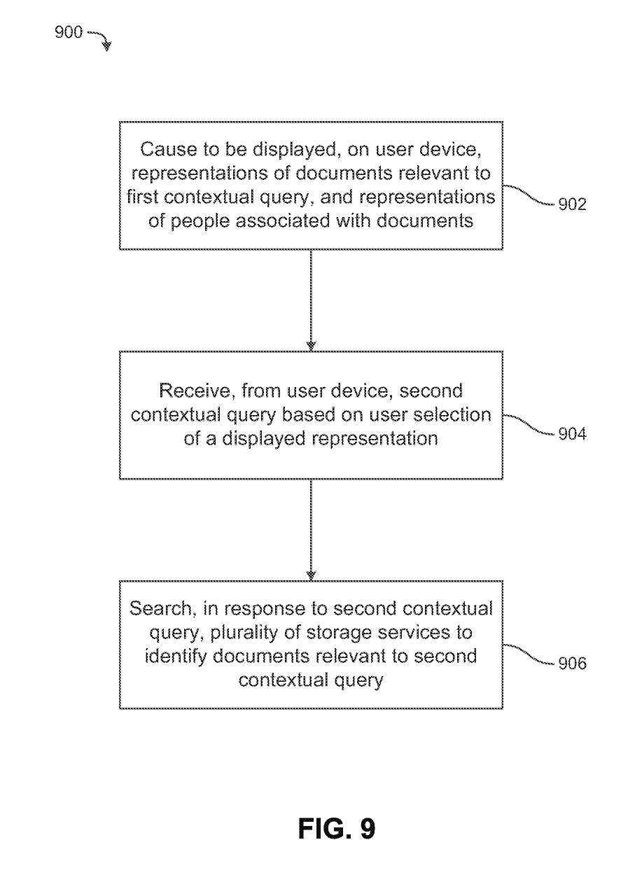

FIG. 9 is a flowchart of an example method 900 for initiating a contextual query for documents. Although execution of method 900 is described below with reference to server apparatus 100 of FIG. 1, it should be understood that execution of method 900 may be performed by other suitable devices, such as server apparatus 200. Method 900 may be implemented in the form of executable instructions stored on a machine-readable storage medium, such as memory 120, and/or in the form of electronic circuitry.

Method 900 may start in block 902, where server apparatus 100 may cause to be displayed, on a user device, representations of documents relevant to a first contextual query, and representations of people associated with the documents. In some implementations, server apparatus 100 may transmit instructions for rendering the representations to a user device, such as user device 140 or 150. The representations may be arranged in a star diagram, as discussed above with respect to FIGS. 5A and 5B.

In block 904, server apparatus 100 may receive, from a user device, a second contextual query based on a user selection of a displayed representation. In block 906, server apparatus 100 may search, in response to the second contextual query, a plurality of storage services to identify documents relevant to the second contextual query. Relevance of documents to the second contextual query may be determined based on contextual metadata stored on server apparatus 100.

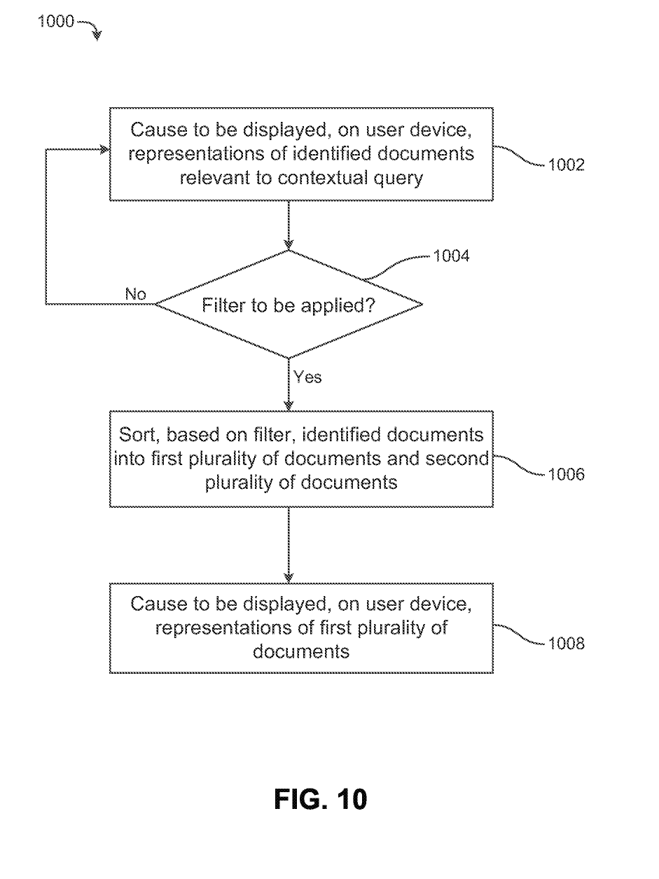

FIG. 10 is a flowchart of an example method 1000 for displaying representations of documents relevant to a contextual query. Although execution of method 1000 is described below with reference to server apparatus 200 of FIG. 2, it should be understood that execution of method 1000 may be performed by other suitable devices, such as server apparatus 100. Method 1000 may be implemented in the form of executable instructions stored on a machine-readable storage medium, such as memory 220, and/or in the form of electronic circuitry.

Method 1000 may start in block 1002, where server apparatus 200 may cause to be displayed, on a user device, representations of identified documents relevant to a contextual query. In some implementations, server apparatus 200 may transmit instructions for rendering the representations to a user device, such as user device 240 or 250. The representations may be arranged in a star diagram, as discussed above with respect to FIGS. 5A and 5B.

In block 1004, server apparatus 200 may determine whether a filter is to be applied. Circumstances in which a filter may be applied are discussed above with respect to FIG. 5A. When server apparatus 200 determines that a filter is not to be applied, method 1000 may loop back to block 1002. When server apparatus 200 determines that a filter is to be applied, method 1000 may proceed to block 1006, in which server apparatus 200 may sort, based on the filter, the identified documents into a first plurality of documents and a second plurality of documents. The first plurality of documents may include documents that meet a criterion of the filter, and the second plurality of documents may include documents that do not meet the criterion of the filter.

Finally, in block 1008, server apparatus 200 may cause to be displayed, on the user device, representations of the first plurality of documents. In some implementations, server apparatus 200 may transmit instructions for rendering the representations of the first plurality of documents to a user device, such as user device 240 or 250. The representations of the first plurality of documents may be arranged in a star diagram similar to those shown in visualizations 500 and 550 of FIGS. 5A and 5B, respectively.

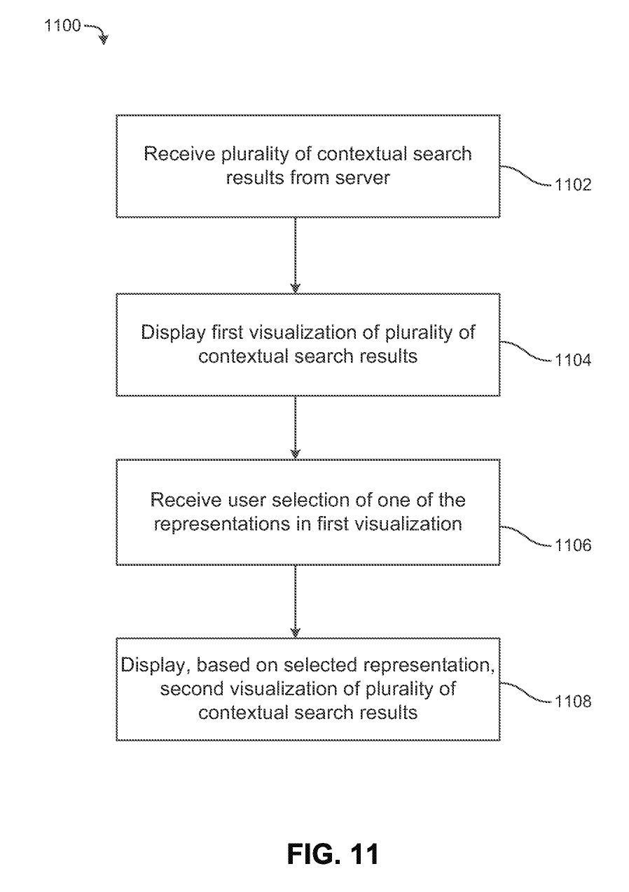

FIG. 11 is a flowchart of an example method 1100 for displaying visualizations of contextual search results. Although execution of method 1100 is described below with reference to computing device 300 of FIG. 3, it should be understood that execution of method 1100 may be performed by other suitable devices, such as computing device 400. Method 1100 may be implemented in the form of executable instructions stored on a machine-readable storage medium, such as storage medium 304, and/or in the form of electronic circuitry.

Method 1100 may start in block 1102, where computing device 300 may receive a plurality of contextual search results from a server. The plurality of contextual search results may be relevant to a contextual query, and may identify a plurality of documents stored using different storage services communicatively coupled to the server.

Next, in block 1104, computing device 300 may display a first visualization of the plurality of contextual search results. The first visualization may look similar to visualization 500 of FIG. 5A. In particular, the first visualization may include representations of documents relevant to the contextual query, and may include representations of people associated with the documents. The representations may be arranged in a star diagram.

In block 1106, computing device 300 may receive a user selection of one of the representations in the first visualization. A user selection may be made, for example, by placing a cursor on one of the representations, or, in a case where computing device 300 is a touch screen device, by tapping a region of the screen where a representation is displayed.

Finally, in block 1108, computing device 300 may display, based on the selected representation, a second visualization of the plurality of contextual search results. The second visualization may include representations of a subset of the documents relevant to the contextual query, and such representations may be in different positions in the second visualization than in the first visualization. For example, visualization 500 may be the first visualization and visualization 550 may be the second visualization; boxes 560 and 574 in visualization 550 are in different positions than corresponding boxes 510 and 528 in visualization 500. The second visualization may also include representations of documents and/or people that did not appear in the first visualization.

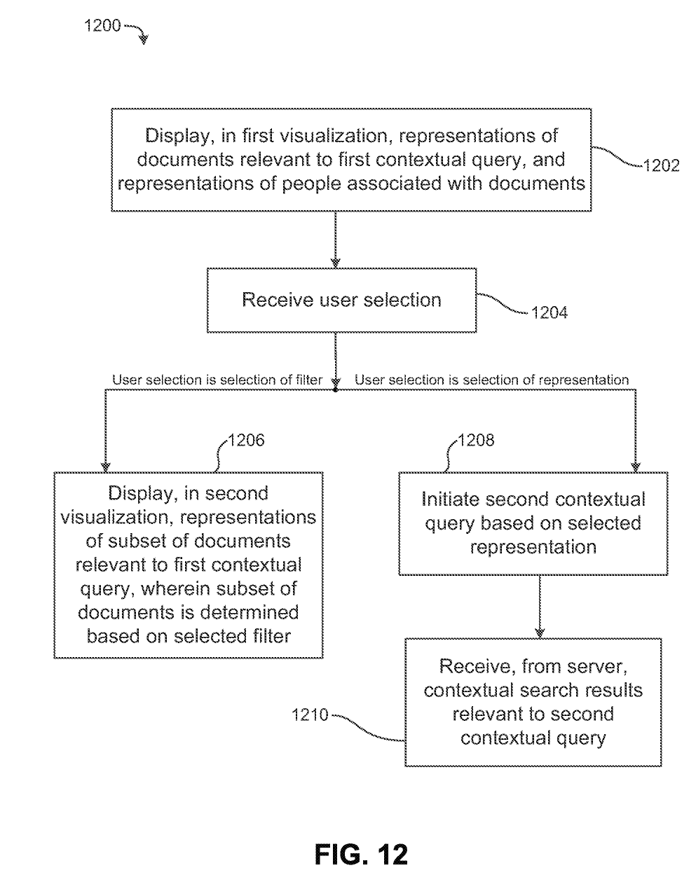

FIG. 12 is a flowchart of an example method 1200 for modifying a display based on a user selection. Although execution of method 1200 is described below with reference to computing device 400 of FIG. 4, it should be understood that execution of method 1200 may be performed by other suitable devices, such as computing device 300. Method 1200 may be implemented in the form of executable instructions stored on a machine-readable storage medium, such as storage medium 404, and/or in the form of electronic circuitry.

Method 1200 may start in block 1202, where computing device 400 may display, in a first visualization, representations of documents relevant to a first contextual query, and representations of people associated with the documents. The representations may be arranged in a star diagram, as discussed above with respect to FIGS. 5A and 5B. A size of a representation may be based on a level of relevance of the respective document or person to the first contextual query.

In block 1204, computing device 400 may receive a user selection. The user selection may be of a displayed representation or of a filter (e.g. one of icons 530, 532, 534, 536, and 538 of visualization 500). When the user selection is a selection of a filter, method 1200 may proceed to block 1206, in which computing device 400 may display, in a second visualization, representations of a subset of the documents relevant to the first contextual query. The subset of the documents may be determined based on the selected filter. For example, the subset may include documents that meet a criterion of the selected filter, and may not include documents that do not meet a criterion of the selected filter.

When the user selection is a selection of a representation, method 1200 may proceed to block 1208, in which computing device 400 may initiate a second contextual query based on the selected representation. Computing device 400 may transmit the second contextual query to a server, such as server apparatus 100 or 200, to request a search for documents relevant to the document/person corresponding to the selected representation. Method 1200 may then proceed to block 1210.

In block 1210, computing device 400 may receive, from the server, contextual search results relevant to the second contextual query. The contextual search results relevant to the second contextual query may identify documents that are stored using a plurality of storage services communicatively coupled to the server and that are relevant to the document/person corresponding to the selected representation.

The foregoing disclosure describes contextually searching for documents. Example implementations described herein enable identifying documents relevant to a contextual query, regardless of which storage services are used to store the documents. Relevance of documents to the contextual query may be based on contextual metadata that is generated based on information received from user devices and that is stored on a server communicatively coupled to the user devices and to the storage services.

We claim:

1. A method for contextually searching for documents, the method comprising:
maintaining, on a server, contextual metadata associated with documents stored using a plurality of storage services, wherein the contextual metadata comprises indications of circumstances under which documents are created or accessed;
searching, in response to a first contextual query, the plurality of storage services to identify documents relevant to the first contextual query, wherein the first contextual query specifies a circumstance under which documents are created or accessed, and wherein relevance of documents to the first contextual query is determined based on the contextual metadata; and
causing to be displayed, on a first user device, representations of the identified documents, wherein representations of identified documents stored using different storage services are concurrently displayed.

2. The method of claim 1, wherein:
the contextual metadata comprises indications of locations where documents were created or accessed, or of events or situations for which documents were created or accessed; and
the first contextual query specifies a location, event, or situation.

3. The method of claim 1, further comprising:
receiving information from the first user device; and
generating, based on the received information, contextual metadata associated with a document accessed using a second user device.

4. The method of claim 1, further comprising causing to be displayed, on the first user device, representations of people associated with the identified documents, wherein people associated with the identified documents are identified based on the contextual metadata stored on the server.

5. The method of claim 4, further comprising:
receiving, from the first user device, a second contextual query based on a user selection of a displayed representation; and
searching, in response to the second contextual query, the plurality of storage services to identify documents relevant to the second contextual query, wherein relevance of documents to the second contextual query is determined based on the contextual metadata stored on the server.

6. A system for contextually searching for documents, the system comprising:
a processor to:
receive information from a plurality of user devices;
generate, based on the received information, contextual metadata associated with documents stored using a plurality of storage services, wherein the contextual metadata comprises indications of circumstances under which documents are created or accessed; and
search, in response to a contextual query, the plurality of storage services to identify documents relevant to the contextual query, wherein the first contextual query specifies a circumstance under which documents are created or accessed, and wherein relevance of documents to the contextual query is determined based on the generated contextual metadata; and
a memory to store the generated contextual metadata.

7. The system of claim 6, wherein the plurality of user devices comprises a first user device and a second user device, and wherein the processor is further to generate, based on information received from the first user device, contextual metadata associated with a document accessed using the second user device.

8. The system of claim 6, wherein the processor is further to cause to be displayed, on one of the plurality of user devices, representations of the identified documents, wherein representations of identified documents stored using different storage services are concurrently displayed.

9. The system of claim 6, wherein the processor is further to:
sort, based on a filter, the identified documents into a first plurality of documents and a second plurality of documents; and
cause to be displayed, on one of the plurality of user devices, representations of the first plurality of documents.

10. The system of claim 6, wherein:
the contextual metadata comprises indications of locations where documents were created or accessed, or of events or situations for which documents were created or accessed; and
the first contextual query specifies a location, event, or situation.

11. A machine-readable storage medium encoded with instructions executable by a processor of a computing device for displaying results of a contextual search, the machine-readable storage medium comprising:
instructions to receive a first plurality of contextual search results from a server, wherein:
the first plurality of contextual search results are relevant to a contextual query, wherein the first contextual query specifies a circumstance under which documents are created or accessed; and
the first plurality of contextual search results identify a first plurality of documents stored using different storage services;
instructions to display a first visualization of the first plurality of contextual search results, wherein the first visualization comprises representations of the first plurality of documents and representations of a first plurality of people associated with the first plurality of documents;
instructions to receive a user selection of one of the representations in the first visualization; and
instructions to display, based on the selected representation, a second visualization of the first plurality of contextual search results.

12. The machine-readable storage medium of claim 11, wherein a size of a representation is based on a level of relevance of a respective one of the first plurality of documents, or a level of relevance of a respective one of the first plurality of people, to the first contextual query.

13. The machine-readable storage medium of claim 11, further comprising:
instructions to receive a user selection of a filter to apply to the first plurality of documents; and
instructions to display, in the second visualization, representations of a subset of the first plurality of documents, wherein the subset of the first plurality of documents is determined based on the selected filter.

14. The machine-readable storage medium of claim 11, further comprising:
instructions to initiate a second contextual query based on the selected representation; and
instructions to receive, from the server, a second plurality of contextual search results relevant to the second contextual query, wherein the second plurality of contextual search results identify a second plurality of documents stored using the plurality of storage services.

15. The machine-readable storage medium of claim 14, wherein the second visualization comprises representations of the second plurality of documents and representations of a subset of the first plurality of documents.
